(19) United States
(12) Patent Application Publication
(10) Pub. No.: US 2008/0098153 A1
(43) Pub. Date: Apr. 24, 2008

(54) Memory access controller

(76) Inventors: Yasuo Nishioka, Osaka (JP); Takahide Baba, Hyogo (JP); Seiji Horii, Osaka (JP); Yoshiharu Watanabe, Osaka (JP)

Correspondence Address: MCDERMOTT WILL & EMERY LLP, 600 13TH STREET, NW, WASHINGTON, DC, 20005-3096, US

(21) Appl. No.: 11/892,334

(22) Filed: Aug. 22, 2007

(30) Foreign Application Priority Data
Oct. 19, 2006 (JP) 2006-285018

(51) Int. Cl. G06F 12/06

(52) U.S. Cl. 711/5; 711/E12.002

(57) ABSTRACT

A memory access controller includes: an access request bank analyzer which generates access request bank information indicative of a bank of a memory to be accessed according to a memory access request signal; a bank use state information holder for holding the access request bank information for a predetermined period to use the held information as bank use state information; and an access permission signal generator for generating, based on the access request bank information and the bank use state information, an access permission signal which is to be used for controlling whether or not to accept a subsequent memory bank access. The bank use state information regarding an access-permitted memory bank is updated according to the access information, such as transfer direction information, access unit information, memory initialization information, etc.

### BACKGROUND OF THE INVENTION

The present invention relates to a memory access controller in a system which has a plurality of banks.

In a data processing system, when an arithmetic processing unit (master), such as a processor, a graphic engine, or the like, accesses a memory having a plurality of banks, the arithmetic processing unit determines a memory bank to access based on an address of a previous access and an address of a succeeding access and determines whether or not a request for a succeeding access to the same memory bank is to be accepted, thereby controlling conflict of memory accesses.

However, the memory width for access is fixed and, in the case of a memory access with a data width smaller than the fixed value (maximum memory width), i.e., in the case of a memory access with a real access data width, part of the bank equivalent to “the maximum memory width minus the real access data width” is included in a busy area even though it is not actually targeted for access. As a result, another memory access to the part of the bank equivalent to “the maximum memory width minus the real access data width” is disadvantageously denied.

In view of such a disadvantage, a conventional technique calculates an address to be used from among addresses which are being accessed to determine a bank which is being actually used from among a plurality of banks, whereby access to another bank is enabled (see Japanese Laid-Open Patent Publication No. 2-202650).

### SUMMARY OF THE INVENTION

The conventional technique determines a bank to be used by calculating a distance between elements based on the first and final addresses. Therefore, a memory bank which is to be actually used cannot be determined before completion of at least two accesses to the first address and final address. Thus, there is a probability that the accessibility decreases.

In view of the above circumstances, an objective of the present invention is to provide a memory access controller with high accessibility wherein the bank width which is to be shown as being busy is limited to the extent of a bank access such that the other area of the bank is set free, and flexible memory access control is provided by using address information and access information such that the free part of the bank is accessible.

To achieve the above objective, according to the present invention, a memory access controller used in a system which has a plurality of banks includes: an access request bank analyzer which generates, based on address information and access information supplied at the time of an access to a memory, access request bank information indicative of a bank of the memory to be accessed; a bank use state information holder for holding the access request bank information for a predetermined period to use the held information as bank use state information; and an access permission signal generator for generating, based on the access request bank information and the bank use state information, an access permission signal which is to be used for controlling whether or not to accept a subsequent memory bank access. The bank use state information holder updates the bank use state information regarding an access-permitted memory bank according to the access information such that conflicting accesses to a same memory bank are controlled according to the access information.

Herein, the access information may be any of transfer direction information, access unit information, master information, slave clock gear ratio information, master clock gear ratio information, remapping information, use scene information, temperature information, fault detection information, and memory initialization information.

According to the present invention, the acceptability of a memory access is controlled according to received access information such that inaccessible memory banks are reduced while accessible memory banks are increased, whereby the accessibility is improved.

According to the present invention, optimum memory access is achieved according to the type of an access by a processor (master), the method for using a memory, the system environment, the state of a memory, etc.

### BRIEF DESCRIPTION OF THE DRAWINGS

FIG. 1 is a block diagram showing an example of a structure of a system which has a memory access controller according to the present invention.

FIG. 2 is a timing chart illustrating an example of an operation of the memory access controller of FIG. 1.

FIG. 3 is a timing chart illustrating another example of an operation of the memory access controller of FIG. 1.

### DESCRIPTION OF THE PREFERRED EMBODIMENTS

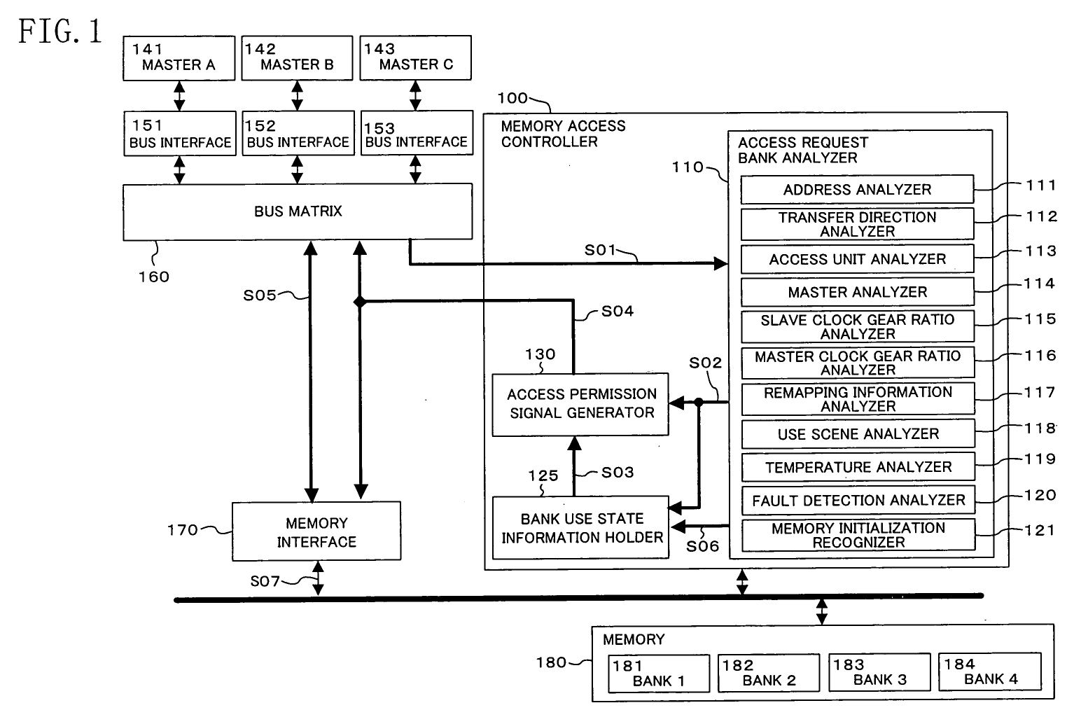

FIG. 1 is a block diagram showing an example of a structure of a system which has a memory access controller according to the present invention. In the system of FIG. 1, a plurality of bus masters 141, 142 and 143 share a memory 180. The system further includes a memory access controller 100, bus interfaces 151, 152 and 153, a bus matrix 160, and a memory interface 170.

The memory 180 includes, for example, four banks 181, 182, 183 and 184. In the descriptions below, these four banks 181, 182, 183 and 184 are referred to as Bank 1, Bank 2, Bank 3 and Bank 4, respectively. The three bus masters 141, 142 and 143 are sometimes referred to as Master A, Master B and Master C, respectively.

The memory access controller 100 includes an access request bank analyzer 110, a bank use state information holder 125, and an access permission signal generator 130.

The bus masters 141, 142 and 143 are processors which request memory accesses with different bus protocols and different data widths. The memory access requests from the bus masters 141, 142 and 143 are converted to the same protocol and shaped to have the same data width by the bus interfaces 151, 152 and 153. The bus matrix 160 arbitrates the memory accesses from the bus masters 141, 142 and 143 according to an arbitration method implemented by hardware or software, thereby controlling the accesses. The result of the arbitration by the bus matrix 160 among the memory accesses from the bus masters 141, 142 and 143 is input in the form of memory access request signal S01, which includes address information and access information, to the memory access controller 100.

In the memory access controller 100, the access request bank analyzer 110 generates based on the address information and access information of memory access request signal S01 access request bank information S02 indicative of to which bank an access request is directed. The access permission signal generator 130 compares access request bank information S02 and bank use state information S03 of the bank use state information holder 125. If information S02 and information S03 indicate access requests to the same bank while information S03 indicates that at least one of the banks to which access requests have been issued is currently busy, access permission signal S04 is set to indicate “access unpermitted”. If information S02 and information S03 indicate access requests to the same bank while information S03 indicates that none of the banks to which access requests have been issued is currently busy (i.e., every one of the banks is free), access permission signal S04 is set to indicate “access permitted”. The bank use state information holder 125 sets bank use state information S03 of a bank specified by the address information of a memory access permitted by access permission signal S04 to “busy” and, after passage of a predetermined period determined according to access information S06 from the access request bank analyzer 110, or when access information S06 meets a predetermined condition, updates bank use state information S03 such that the bank is shown as being “free”.

The bus matrix 160 determines based on access permission signal S04 whether or not memory access request signal S01 for which an access permission has been currently issued as a result of arbitration is allowable for memory access. If access permission signal S04 indicates “access permitted”, arbitration is carried out on subsequent accesses. If access permission signal S04 indicates “access unpermitted”, the bus matrix 160 holds the arbitration result till subsequent determination as to access permission occurs and then continues to request a permission for access from the memory access controller 100.

Access permission signal S04 is also input to the memory interface 170 at the same time. Memory access S05 permitted for access by the memory access controller 100 is converted by the memory interface 170 to a protocol suitable to memory access and is transmitted as memory access signal S07 to the memory 180. Herein, the memory interface 170 carries out an access while activating only part of the bank equivalent to a data width determined to be actually necessary based on address information, access size information, etc.

The access request bank analyzer 110 includes an address analyzer 111, a transfer direction analyzer 112, an access unit analyzer 113, a master analyzer 114, a slave clock gear ratio analyzer 115, a master clock gear ratio analyzer 116, a remapping information analyzer 117, a use scene analyzer 118, a temperature analyzer 119, a fault detection analyzer 120, and a memory initialization recognizer 121.

The address analyzer 111 generates based on the address information of memory access request signal S01 access request bank information S02 indicative of to which bank an access request is directed.

The transfer direction analyzer 112 supplies transfer direction information as access information S06 to the bank use state information holder 125. The transfer direction information is information explicitly designated by each of the bus masters 141, 142 and 143 to the memory access controller 100 as to whether an access to the memory 180 is a write access or read access. Therefore, when the memory 180 has different completion times for a read access and write access, or when the difference between the completion times for a read access and write access results from a non-memory factor, the access-prohibited time can be set for an access to a memory bank according to each of the read access and write access. For example, the read access requires several cycles of data waiting interval. However, in the case of a write access, if the memory 180 is accessible every cycle, the access-prohibited time for several cycles is set only for the read access while such setting is unnecessary for the write access. Thus, circuit cost is suppressed while the accessibility of the write access need not to be adjusted to that of the read access. Therefore, the accessibility for the entire operation can be improved.

The access unit analyzer 113 supplies access unit information as access information S06 to the bank use state information holder 125. The access unit information is information explicitly designated by each of the bus masters 141, 142 and 143 to the memory access controller 100 as to the unit of access to the memory 180. With the access unit information, such an undesirable result is avoided that part of the bank is included in a busy area even though it is not actually targeted for access and a memory access to another bank is denied. The bank width which is to be shown as being busy is limited to the width of a bank access, whereby the other area of the bank is set free so that the free part of the bank is accessible.

The master analyzer 114 supplies master information as access information S06 to the bank use state information holder 125. The master information is information explicitly designated by each of the bus masters 141, 142 and 143 to the memory access controller 100 as to the unit of access to the memory 180. Therefore, when the unit of access is determined by each of the bus masters 141, 142 and 143, the master analyzer 114 identifies the unit of access according to which master accesses. Part of the bank which is not targeted for access is set free so that the free part of the bank is accessible. In the case where the masters have different required access speeds, the inaccessible time can be set according to the requirements as to the access speed from the masters 141, 142 and 143.

For example, consider a case where a high speed memory and low speed memory are connected and use the same addresses. Herein, Masters A, B and C request different access response times. Master A accesses the high speed memory and Master B accesses the low speed memory, which are automatically switched by the memory interface 170. Each of the bus masters 141, 142 and 143 does not explicitly designate whether it accesses the high speed memory or low speed memory.

It should be noted that the inaccessible periods after the access by Master A and the access by Master B (“busy periods”) may be implemented by hardware in advance or may be settable through a register.

The slave clock gear ratio analyzer 115 supplies slave clock gear ratio information as access information S06 to the bank use state information holder 125. The slave clock gear ratio information is information explicitly designated by each of the bus masters 141, 142 and 143 to the memory access controller 100 as to the clock gear ratio in a system where the clock gear ratio between the memory access controller 100 and the memory 180 is changeable. Therefore, the inaccessible time can be set according to the clock gear ratio.

For example, the clock gear ratio between the memory access controller 100 and the memory 180 is switched between 1:1 and 3:1. The high speed memory is accessed when the clock gear ratio is 1:1, and the low speed memory is accessed when the clock gear ratio is 3:1. With such an arrangement, memory accesses suitable to the clock gear ratio and access control for the memory accesses can readily be carried out.

The master clock gear ratio analyzer 116 supplies master clock gear ratio information as access information S06 to the bank use state information holder 125. The master clock gear ratio information is information explicitly designated by each of the bus masters 141, 142 and 143 to the memory access controller 100 as to the clock gear ratio in a system where the clock gear ratio between each of the bus masters 141, 142 and 143 and the memory access controller 100 is changeable. Therefore, the inaccessible time can be set according to the clock gear ratio.

For example, a high speed memory which is inaccessible for one cycle after an access and a low speed memory which is inaccessible for three cycles after an access are connected. The clock gear ratio between each of the bus masters 141, 142 and 143 and the memory access controller 100 is switched between 1:1 and 3:1. Where the clock of the memory access controller 100 is employed as a reference cycle, if the clock gear ratio is 1:1, the memory is inaccessible for one cycle, and if the clock gear ratio is 3:1, the memory is inaccessible for three cycles.

The remapping information analyzer 117 supplies remapping information as access information S06 to the bank use state information holder 125. The remapping information is information explicitly designated to the memory access controller 100 that data is currently being remapped in a system where addressing of data location in the memory 180 is changeable. Therefore, in a system having a plurality of types of memories of different access speeds, the control of data access to memories of different access speeds with remapping is enabled by setting the inaccessible time according to the specifications regarding the speed of each memory.

The use scene analyzer 118 supplies use scene information as access information S06 to the bank use state information holder 125. The use scene information is information explicitly designated to the memory access controller 100 that data is currently being remapped in a system where addressing can be changed according to the operation speed and memory capacity required by each of the bus masters 141, 142 and 143 which operates based on an application launched by the system, and a plurality of types of memories of different access speeds are switched. Therefore, in a system having a plurality of types of memories of different access speeds, the control of data access based on the speed and capacity required by an application that runs is enabled by setting the inaccessible time according to the specifications regarding the speed of each memory.

For example, the requirements as to the accessibility to the memory 180 differ among use scenes in which the bus masters 141, 142 and 143 operate (operating applications). Each of the bus masters 141, 142 and 143 designates the use scene information explicitly classified into some categories to the memory access controller 100. The use scene analyzer 118 of the memory access controller 100 designates whether to access the high speed memory or low speed memory based on the received use scene information and the requested accessibility for respective use scenes designated by hardware or software in advance. The instruction as to whether to access the high speed memory or low speed memory is also directed to the memory interface 170 at the same time. The memory interface 170 allocates actual accesses to the high speed memory or low speed memory according to the instruction.

The temperature analyzer 119 supplies temperature information as access information S06 to the bank use state information holder 125. The temperature information is information explicitly designated to the memory access controller 100 that, in a system where a plurality of types of memories of different access speeds are switched according to the temperature obtained from an environment in which the system operates, the type of memory used is switched by addressing according to the varying temperature. Therefore, in a system having a plurality of types of memories of different access speeds, access to a memory which is inoperable in view of the specifications due to the temperature characteristic of an environment where the system operates, etc., is stopped, and the control of accessing an operable memory is enabled by setting the inaccessible time according to the specifications regarding the speed of each memory.

For example, the delay of memory access varies according to the temperature at which the memory 180 and the memory access controller 100 operate. If the temperature is lower than a predetermined temperature, an access to the high speed memory is carried out. If the temperature is higher than a predetermined temperature, an access to the low speed memory is carried out. The temperature analyzer 119 of the memory access controller 100 designates whether to access the high speed memory or low speed memory based on a table of the relationships between the received temperature information, the temperatures designated by hardware or software in advance, and operable memories. The instruction as to whether to access the high speed memory or low speed memory is also directed to the memory interface 170 at the same time. The memory interface 170 allocates actual accesses to the high speed memory or low speed memory according to the instruction.

The fault detection analyzer 120 supplies fault detection information as access information S06 to the bank use state information holder 125. The fault detection information is information explicitly designated to the memory access controller 100 that, in a system capable of distinguishing whether or not the memory 180 is operable, a fault memory is avoided such that an employable memory is selected. Therefore, in a system having a fault detection function, access to a fault memory is stopped, and the control of accessing an operable memory is enabled by setting the inaccessible time according to the specifications regarding the speed of each memory.

For example, where a high speed memory is used as a main memory, detection of a fault in the high speed memory by the fault detection function triggers the use of a reserve low speed memory. The fault detection analyzer 120 of the memory access controller 100 designates whether to access the high speed memory or low speed memory based on a table of the relationships between the received fault detection information and the memories operable at the time of detection of a fault which are designated by hardware or software in advance. The instruction as to whether to access the high speed memory or low speed memory is also directed to the memory interface 170 at the same time. The memory interface 170 allocates actual accesses to the high speed memory or low speed memory according to the instruction.

The memory initialization recognizer 121 supplies memory initialization information as access information S06 to the bank use state information holder 125. The memory initialization information is information explicitly designated to the memory access controller 100 that, in a system which initializes a memory before use, a memory which is currently in the midst of initialization is avoided such that an employable memory is selected. Therefore, in a system having a function of detecting initialization, access to a memory which is currently in the midst of initialization is stopped, and the control of accessing an operable memory is enabled by setting the inaccessible time according to the specifications regarding the speed of each memory.

For example, where a high speed memory is used as a main memory, if the memory initialization detection function detects that the high speed memory is currently in the midst of initialization, a reserve low speed memory is used. The memory initialization recognizer 121 of the memory access controller 100 designates whether to access the high speed memory or low speed memory based on a table of the relationships between the received memory initialization information and the memories operable during initialization and at the time of completion of the initialization which are designated by hardware or software in advance. The instruction as to whether to access the high speed memory or low speed memory is also directed to the memory interface 170 at the same time. The memory interface 170 allocates actual accesses to the high speed memory or low speed memory according to the instruction.

It should be noted that the inaccessible periods after the access to the high speed memory and the access to the low speed memory (“busy periods”) may be implemented by hardware in advance or may be settable through a register.

Hereinabove, utilization of the transfer direction information, access unit information, master information, etc., has been generally described. Hereinafter, utilization of the transfer direction information and access unit information, in particular, is described in detail with reference to the drawings.

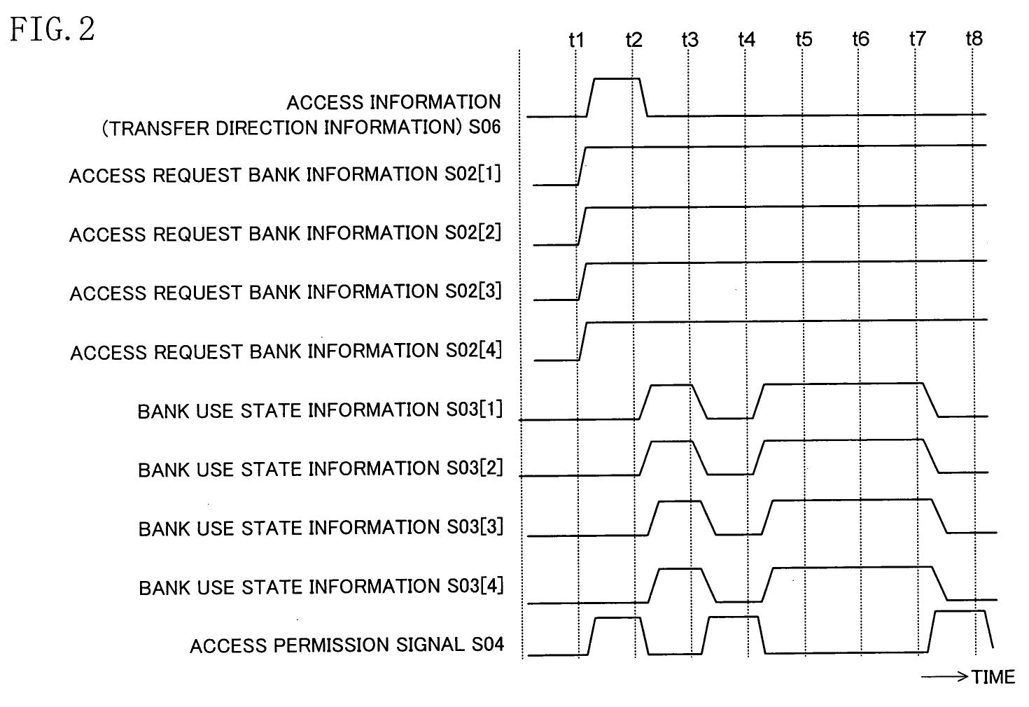

FIG. 2 is a timing chart illustrating an example of a process flow according to this embodiment for updating bank use state information S03 where access information S06 input to the bank use state information holder 125 of FIG. 1 is the transfer direction information. The transfer direction information is added to memory access request signal S01 and input to the access request bank analyzer 110 and the bank use state information holder 125. Access to a connected memory 180 is restricted such that the memory 180 is inaccessible for one cycle after a write access and is inaccessible for three cycles after a read access.

Transfer direction information S06 of FIG. 2 indicates a write access when it is HIGH and indicates a read access when it is LOW. Access request bank information S02[1] to S02[4] are access requests for Bank 1 to Bank 4, respectively, which are obtained by decoding the address information in the access request bank analyzer 110. If the access request bank information is HIGH, there is an access request. If the access request bank information is LOW, there is no access request. Bank use state information S03[1] to S03[4] are bank use state information of Bank 1 to Bank 4, respectively, which are obtained in the bank use state information holder 125. If the bank use state information is LOW, a corresponding bank is “free”. If the bank use state information is HIGH, a corresponding bank is “busy”. If access permission signal S04 is LOW, it indicates “inaccessible”. If access permission signal S04 is HIGH, it indicates “accessible”. When there is no access request, access permission signal S04 is LOW.

Referring to FIG. 2, Bank 1 to Bank 4 are all “free” at Time t1 (bank use state information S03[1] to S03[4] are all LOW). At Time t2, access requests of write access are issued to Bank 1 to Bank 4 (transfer direction information S06 is HIGH while access request bank information S02[1] to S02[4] are HIGH). Since at Time t2 access-requested Bank I to Bank 4 are all “free” (bank use state information S03[1] to S03[4] are all LOW), the access requests are accepted, i.e., “access permitted” (access permission signal S04 is HIGH). Bank use state information S03[1] to S03[4] corresponding to the banks which have been “access-permitted” at Time t2 become “busy (HIGH)” at Time t3, so that read access requests to Bank 1 to Bank 4 (transfer direction information S06 is LOW while access request bank information S02[1] to S02[4] are HIGH) are rejected, i.e., “inaccessible” (access permission signal S04 is LOW). At Time t4, the “busy” state for the write access is canceled to be “free” (bank use state information S03[1] to S03[4] are all LOW). Thus, the read access requests to Bank 1 to Bank 4 (transfer direction information S06 is LOW while access request bank information S02[1] to S02[4] are HIGH) are accepted at Time t4 (access permission signal S04 is HIGH). Likewise, Bank 1 to Bank 4 are “busy” over three cycles from Time t5 to Time t7 (bank use state information S03[1] to S03[4] are HIGH). At Time t8, Bank 1 to Bank 4 become “free” (bank use state information S03[1] to S03[4] are LOW).

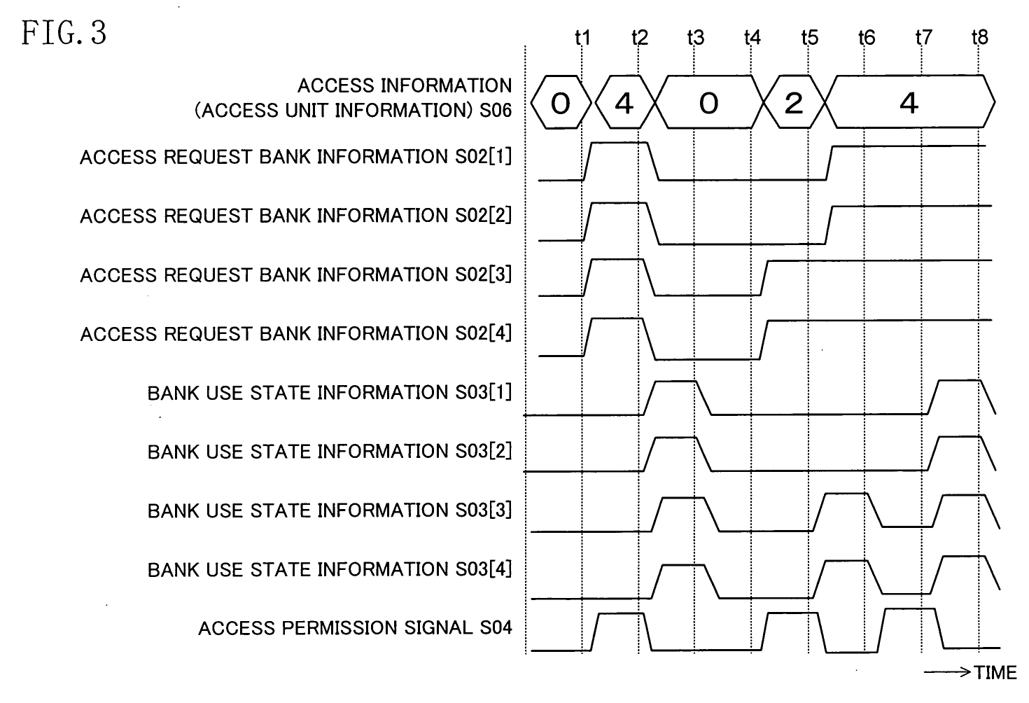

FIG. 3 is a timing chart illustrating another example of a process flow according to this embodiment for updating bank use state information S03 where access information S06 input to the bank use state information holder 125 of FIG. 1 is the access unit information. The access unit information is added to memory access request signal S01 and input to the access request bank analyzer 110 and the bank use state information holder 125. The memory 180 is inaccessible for one cycle after an access. The numbers shown in the row of access unit information S06 of FIG. 3 each represent the number of access-requested banks.

Referring to FIG. 3, Bank 1 to Bank 4 are all “free” at Time t1 (bank use state information S03[1] to S03[4] are all LOW). At Time t2, access requests are issued to Bank 1 to Bank 4 (access unit information S06 is 4 while access request bank information S02[1] to S02[4] are HIGH). Since at Time t2 access-requested Bank 1 to Bank 4 are all “free” (bank use state information S03[1] to S03[4] are all LOW), the access requests are accepted, i.e., “access permitted” (access permission signal S04 is HIGH). At Time t5, access requests are issued to Bank 3 and Bank 4 (access unit information S06 is 2 while access request bank information S02[3] and S02[4] are HIGH). Since at Time t5 access-requested Bank 3 and Bank 4 are “free” (bank use state information S03[3] and S03[4] are LOW), the access requests are accepted, i.e., “access permitted” (access permission signal S04 is HIGH). Bank use state information S03[3] and S03[4] corresponding to Bank 3 and Bank 4 which have been “access-permitted” at Time t5 become “busy (HIGH)” at Time t6, so that access requests to Bank 1 to Bank 4 at Time t6 (access unit information S06 is 4 while access request bank information S02[1] to S02[4] are HIGH) are rejected, i.e., “inaccessible” (access permission signal S04 is LOW). At Time t7, the “busy” state of Bank 3 and Bank 4 is canceled to be “free” (bank use state information S03[3] and S03[4] are LOW). Thus, the access requests to Bank 1 to Bank 4 (access unit information S06 is 4 while access request bank information S02[1] to S02[4] are HIGH) are accepted at Time t7 (access permission signal S04 is HIGH).

Hereinabove, the memory access controller 100 shown in FIG. 1 has been described. According to the present invention, however, the memory access controller 100 and the memory 180 may be in the same chip. The memory 180 may be an external memory existing in a chip different from the chip in which the memory access controller 100 is incorporated. The access request bank analyzer 110 may be realized by hardware or may be realized by a program.

As described hereinabove, a memory access controller of the present invention controls access requests to a memory which has a plurality of banks based on address information and access information to control memory accesses according to the types of the accesses, the conditions of a system, the type of the memory, etc., and is therefore useful for a system where a memory having a plurality of banks is accessed.

What is claimed is:

1. A memory access controller used in a system which has a plurality of banks, comprising:
an access request bank analyzer which generates, based on address information and access information supplied at the time of an access to a memory, access request bank information indicative of a bank of the memory to be accessed;
a bank use state information holder for holding the access request bank information for a predetermined period to use the held information as bank use state information; and
an access permission signal generator for generating, based on the access request bank information and the bank use state information, an access permission signal which is to be used for controlling whether or not to accept a subsequent memory bank access,
wherein the bank use state information holder updates the bank use state information regarding an access-permitted memory bank according to the access information such that conflicting accesses to a same memory bank are controlled according to the access information.

2. The memory access controller of claim 1, wherein the access information is transfer direction information indicative of whether the access to the memory is a read access or a write access.

3. The memory access controller of claim 2, wherein the access permission signal generator generates the access permission signal based on the address information and the transfer direction information such that a memory access is rejected during a predetermined interval.

4. The memory access controller of claim 1, wherein the access information is access unit information indicative of the unit of access to the memory.

5. The memory access controller of claim 4, wherein the access permission signal generator generates the access permission signal based on the address information and the access unit information such that only a memory having a bit width equal to the unit of access is activated and that only an accessed bank rejects a memory access during a predetermined interval.

6. The memory access controller of claim 1, wherein the access information is master information uniquely indicative of the type of a processor which is currently accessing the memory.

7. The memory access controller of claim 6, wherein:
the access request bank analyzer analyzes a bank of an accessed memory based on the address information and the master information; and
the access permission signal generator generates the access permission signal such that only an accessed bank rejects a memory access only during an interval determined based on the master information.

8. The memory access controller of claim 1, wherein the access information is slave clock gear ratio information indicative of a clock gear ratio between the memory and the memory access controller.

9. The memory access controller of claim 8, wherein
the access request bank analyzer analyzes a bank of an accessed memory based on the address information and the slave clock gear ratio information; and
the access permission signal generator generates the access permission signal such that a memory access is rejected only during an interval determined based on the clock gear ratio.

10. The memory access controller of claim 1, wherein the access information is master clock gear ratio information indicative of a clock gear ratio between a processor which is currently accessing the memory and the memory access controller.

11. The memory access controller of claim 10, wherein
the access request bank analyzer analyzes a bank of an accessed memory based on the address information and the master clock gear ratio information; and
the access permission signal generator generates the access permission signal such that a memory access is rejected only during an interval determined according to the clock gear ratio.

12. The memory access controller of claim 1, wherein the access information is remapping information indicative of addressing of the memory.

13. The memory access controller of claim 12, wherein
the access request bank analyzer analyzes a bank of a memory to be accessed based on the address information and the remapping information; and
the access permission signal generator generates the access permission signal such that a memory access is rejected only during an interval determined according to the bank of the memory to be accessed which is identified by the remapping information.

14. The memory access controller of claim 1, wherein the access information is use scene information indicative of how an application uses the memory.

15. The memory access controller of claim 14, wherein
the access request bank analyzer analyzes a bank of a memory to be accessed based on the address information and the use scene information; and
the access permission signal generator generates the access permission signal such that a memory access is rejected only during an interval determined according to the bank of the memory to be accessed.

16. The memory access controller of claim 1, wherein the access information is temperature information.

17. The memory access controller of claim 16, wherein
the access request bank analyzer analyzes a bank of a memory to be accessed based on the address information and the temperature information such that the memory to be accessed is physically changed according to the temperature; and
the access permission signal generator generates the access permission signal such that a memory access is rejected only during an interval determined according to the bank of the memory to be accessed.

18. The memory access controller of claim 1, wherein the access information is fault detection information indicative of whether or not the memory has a fault.

19. The memory access controller of claim 18, wherein
the access request bank analyzer analyzes a bank of a memory to be accessed based on the address information and the fault detection information such that the memory to be accessed is physically changed according to whether or not the memory has a fault; and
the access permission signal generator generates the access permission signal such that a memory access is rejected only during an interval determined according to the bank of the memory to be accessed.

20. The memory access controller of claim 1, wherein the access information is memory initialization information indicative of whether or not the access to the memory is in the midst of initialization.

21. The memory access controller of claim 20, wherein
the access request bank analyzer analyzes a bank of a memory to be accessed based on the address information and the initialization information such that the memory to be accessed is physically changed according to whether or not the memory is in the midst of initialization; and
the access permission signal generator generates the access permission signal such that a memory access is rejected only during an interval determined according to the bank of the memory to be accessed.

22. The memory access controller of claim 1, wherein:
the memory having a plurality of banks is arranged in parallel to form a data width N times a maximum access unit of a processor which accesses the memory through the memory access controller, where N is an integer; and
an access to a corresponding memory is controlled according to the access request bank information generated by the access request bank analyzer.

23. The memory access controller of claim 1, wherein only a memory access to a corresponding bank is activated according to the access request bank information generated by the access request bank analyzer to form a data width equal to a minimum access unit of a processor which accesses the memory having a plurality of banks through the memory access controller.
